(19) United States
(12) Patent Application Publication
(10) Pub. No.: US 2015/0045979 A1
(43) Pub. Date: Feb. 12, 2015

(54) MAXIMUM POWER POINT TRACKING SYSTEM AND METHOD FOR TRACKING MAXIMUM POWER POINT OF PHOTOVOLTAIC DEVICE

(71) Applicant: HON HAI PRECISION INDUSTRY CO., LTD., New Taipei (TW)

(72) Inventors: KAI-FU CHEN, New Taipei (TW); CHIA-YUN LEE, New Taipei (TW); CHUANG-WEI TSENG, New Taipei (TW); CHE-HSUN CHEN, New Taipei (TW)

(21) Appl. No.: 14/453,630

(22) Filed: Aug. 7, 2014

(30) Foreign Application Priority Data
Aug. 7, 2013 (TW) 102128388

(51) Int. Cl. G05B 15/02

(52) U.S. Cl. CPC G05B 15/02
USPC 700/297

(57) ABSTRACT

A maximum power point tracking (MPPT) system and method applied to a photovoltaic (PV) device includes an MPPT device and a temperature control device within a load module. The MPPT system includes a control unit, a detection unit, and a determination unit and a first command to increase power to the temperature control device and the detection unit detects output power before the command and output power after the command. The determination unit determines whether the second output power is greater than the first output power. The control unit repeats the first command to the temperature control device when the second output power is greater than the first output power.

### CROSS-REFERENCE TO RELATED APPLICATIONS

This application claims priority to Taiwanese Patent Application No. 102128388 filed on Aug. 7, 2013 in the Taiwan Intellectual Property Office, the contents of which are incorporated by reference herein.

### FIELD

The present disclosure relates to a maximum power point tracking (hereinafter “MPPT”) system and a method for tracking a maximum power point of a photovoltaic device (hereinafter “PV device”).

### BACKGROUND

A photovoltaic device converts solar radiation to electricity. When the PV device provides electricity to a load, a output power of the PV device is determined by a power consumption of the load. If the power consumption of the load is lower than a maximum power point, the PV device cannot be working at the maximum power point.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a MPPT system.

FIG. 2 is a flowchart of an embodiment of a method for tracking a maximum power point of a PV device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising” means “including, but not necessarily limited to”; it specifically indicates open-ended inclusion or membership in a so-described combination, group, series and the like.

The present disclosure is described in relation to an MPPT system and method for tracking a maximum power point of a PV device. The MPPT system includes an MPPT device and a load module. The MPPT device includes a control unit, a detection unit, and a determination unit. The control unit sends an increase-power command to the temperature control device of the load module, to increase power. The detection unit detects a first output power of the PV device before the power of the temperature control device is increased, and detects a second output power after the increase-power command has been given. The determination unit determines whether the second output power is greater than the first output power. The control unit sends a further increase-power command to the temperature control device when the second output power is greater than the first output power.

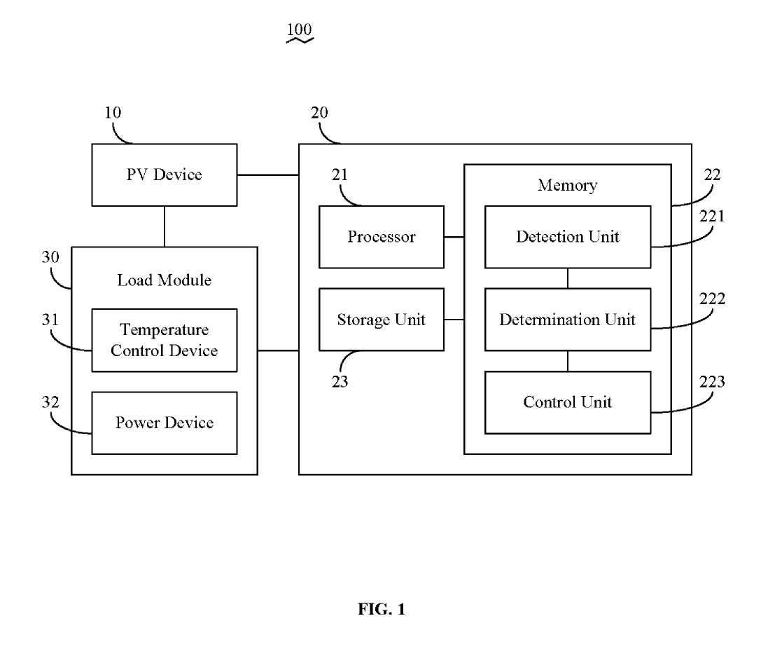

FIG. 1 illustrates an embodiment of an MPPT system. The MPPT system 100 can include a PV device 10 and an MPPT device 20 both coupled to a load module 30. The PV device 10 can include at least one solar panel. The solar panel converts light to electricity and provides power to the MPPT device 20 and the load module 30. The load module 30 can include a temperature control device 31 and a power device 32. The MPPT device 20 is used to detect output power of the PV device 10 and to control the load module 30 to work with a maximum available power.

The MPPT device 20 can include a processor 21 and a storage unit 23. The processor 21 executes instructions of a detection unit 221, a determination unit 222, and a control unit 223. The instructions of the detection unit 221, the determination unit 222, and the control unit 223 are stored in a memory 22.

The control unit 223 sends a first command to the temperature control device 31 to increase power. In at least one embodiment, the temperature control device 31 is an air conditioner, the power device 32 can include at least one server. The air conditioner increases the power it consumes to lower the temperature of the server in response to the first command, if the PV device 10 is able to provide enough power.

The detection unit 221 detects an instant first output power of the PV device 10 before the power of the temperature control device 31 is increased and detects a second instant output power of the PV device 10 after the increase-power command to the temperature control device 31 is given. The storage unit 23 stores the first output power level and the second output power level. In at least one embodiment, the detection unit 221 is a resistance element, which detects the first output power and the second output power through output current and output voltage of the PV device 10.

The determination unit 222 determines whether the second output power is greater than the first output power.

When the second output power is no greater than the first output power, the control unit 223 withdraws the increase-power command. When the second output power is greater than the first output power the control unit 223 repeats the first command to the temperature control device 31. In at least one embodiment, the temperature control device 31 is an air conditioner, the power device 32 can include at least one server. The air conditioner increases the power it consumes to lower the temperature of the server in response to the first command, if the PV device 10 can provide enough power. The working and function of the temperature control device 31 will always be at a maximum level, where the maximum level is a maximum output power of the PV device 10. The temperature control device 31 is then working to a maximum capacity, and then the PV device 10 is functioning at a maximum efficiency.

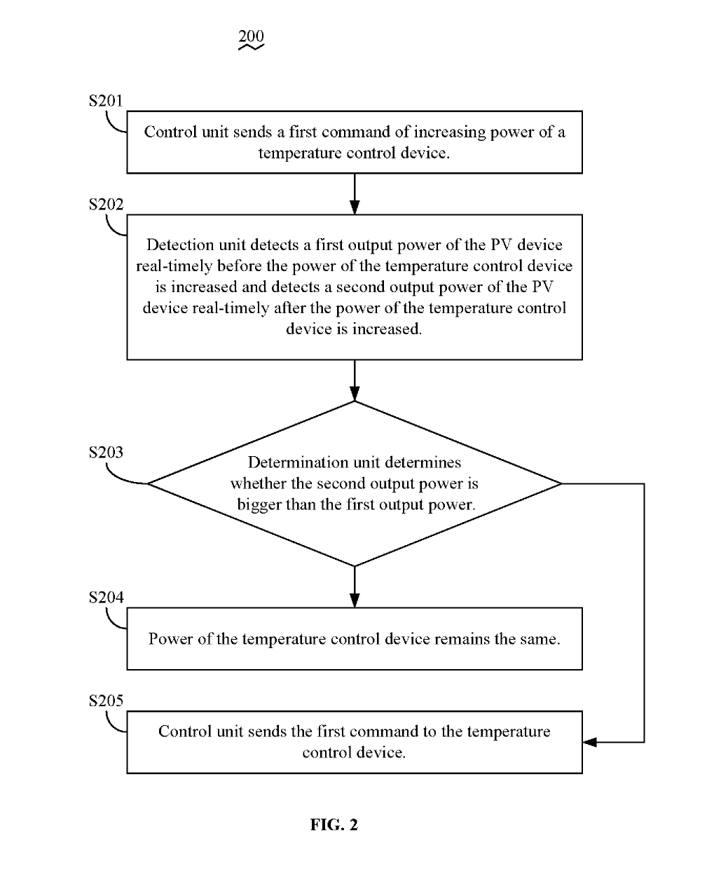

Referring to FIG. 2, a flowchart is presented in accordance with an example embodiment. A method 200 is provided by way of example, as there are a variety of ways to carry out the method. The method 200 described below can be carried out using the configurations illustrated in FIG. 1 and various elements of these figures are referenced in explaining example method 200. Each block shown in FIG. 2 represents one or more processes, methods, or subroutines, carried out in the exemplary method 200. Additionally, the illustrated order of blocks is by example only and the order of the blocks can be changed. The exemplary method 200 can begin at block 201.

At block 201, a control unit sends to a temperature control device a first command to increase power. In at least one embodiment, the temperature control device is an air conditioner, the air conditioner increases the power it consumes to lower temperature of a power device in response to the first command, if a PV device can provide enough power.

At block 202, a detection unit detects an instant first output power of the PV device before the power of the temperature control device is increased and detects an instant second output power of the PV device after the increase-power command is given. A storage unit stores the levels of the first and second output powers. In at least one embodiment, the detection unit is a resistance element, the resistance element detects the first output power and the second output power through output current and output voltage of the PV device.

At block 203, a determination unit determines whether the second output power is greater than the first output power. If the second output power is not greater than the first output power, block 204 is implemented. If the second output power is greater than the first output power, block 205 is implemented.

At block 204, the power of the temperature control device remains the same.

At block 205, the control unit sends the first command to the temperature control device again. The temperature control device will operate at a power level equal to the maximum power available, where the maximum power available is an output power of the PV device operating in its most efficient state. The temperature control device then works with a maximum power, and the PV device works at a maximum power point.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A maximum power point tracking system for tracking a maximum power point of a photovoltaic device, the maximum power point tracking system comprising:
a temperature control device configured to control temperature of a power device;
a control unit configured to send a increase-power command to the temperature control device to increase power;
a detection unit configured to detect a first instant output power of the photovoltaic device before the power of the temperature control device is increased, and detect a second instant output power of the photovoltaic device after the power of the temperature control device is increased; and
a determination unit configured to determine whether the second output power is greater than the first output power, wherein the temperature control device withdraws the increase-power command if the second instant output power is no greater than the first instant output power, and the control unit repeats the increase-power command to the temperature control device if the second instant output power is greater than the first instant output power.

2. The maximum power point tracking system of claim 1, wherein the temperature control device is an air conditioner, and the power device comprising at least one server, the air conditioner increases the power by decreasing temperature of the server and decreases the power by increasing the temperature of the server.

3. The maximum power point tracking system of claim 1, wherein the detection unit is a resistance element, the resistance element detects the first output power and the second output power through output current and output voltage of the photovoltaic device.

4. A maximum power point tracking device for tracking a maximum power point of a photovoltaic device, the maximum power point tracking device comprising:
a processor configured to execute instructions of the following units stored in a memory:
a control unit configured to send a increase-power command to the temperature control device to increase power;
a detection unit configured to detect a first instant output power of the photovoltaic device before the power of the temperature control device is increased, and detect a second instant output power of the photovoltaic device after the power of the temperature control device is increased; and
a determination unit configured to determine whether the second output power is greater than the first output power, wherein the temperature control device withdraws the increase-power command if the second instant output power is no greater than the first instant output power, and the control unit repeats the increase-power command to the temperature control device if the second instant output power is greater than the first instant output power.

5. The maximum power point tracking device of claim 4, wherein the detection unit is a resistance element, the resistance element detects the first output power and the second output power through output current and output voltage of the photovoltaic device.

6. A maximum power point tracking method for tracking a maximum power point of a photovoltaic device, the tracking method comprising:
sending a increase-power command to a temperature control device to increase power;
detecting a first instant output power of the photovoltaic device before the power of the temperature control device is increased, and detect a second instant output power of the photovoltaic device after the power of the temperature control device is increased; and
determining whether the second output power is greater than the first output power, and repeating the increase-power command to the temperature control device if the second instant output power is greater than the first instant output power.

7. The maximum power point tracking method of claim 6, wherein determining whether the second output power is greater than the first output power, and repeating the increase-power command to the temperature control device if the second instant output power is greater than the first instant output power comprising withdrawing the increase-power command if the second instant output power is no greater than the first instant output power.

8. The maximum power point tracking method of claim 6, wherein detecting a first instant output power of the photovoltaic device before the power of the temperature control device is increased, and detect a second instant output power of the photovoltaic device after the power of the temperature control device is increased comprising detecting the first instant output power and the second instant output power through a output current and a output voltage of the photovoltaic device with a resistance element.
